(19) United States
(12) Patent Application Publication
(10) Pub. No.: US 2012/0067480 A1
(43) Pub. Date: Mar. 22, 2012

(54) VEHICLE WINTER TYRE AND STUD FOR THE TYRE

(75) Inventor: Marja Hietarinta-Salakari, Turku (FI)

(73) Assignee: SPIKESAFE OY, Turku (FI)

(21) Appl. No.: 13/321,563

(22) PCT Filed: Apr. 28, 2011
(86) PCT No.: PCT/FI11/50383

§ 371 Date: Nov. 21, 2011

(30) Foreign Application Priority Data
May 3, 2010 (FI) 20100190

(51) Int. Cl. B60C 11/16

(52) U.S. Cl. 152/210

(57) ABSTRACT

A winter tyre is equipped with studs. The number of studs in the tyre is greater than that stated in the amendment, dating 1 Jun. 2009, to the Finnish Ministry of Transport and Communications Decree 408/2003 concerning vehicle tyre studs. The shape of the stud together with the elasticity of the winter tyre rubber compound creates a piercing force of less than 120 N on the stud. The invention also relates to the stud for a tyre, the tip of the stud being resistant to wear and having a cross-section of 1.80-3.14 mm².

This invention relates to a vehicle winter tyre equipped with studs in which the vehicle is intended for normal use and in which the number of studs in the tyre is greater than that stated in the amendment, dated from 1 Jun. 2009, to the Finnish Ministry of Transport and Communications Decree 408/2003 concerning vehicle tyre studs.

For example Finnish patents FI-115620 and FI-115761 address vehicle tyre studs known as such. These studs and stud inventions aim to create lighter weight studs. Winter tyres equipped with lighter studs cause less wear on the surface material of roads, i.e. on asphalt. A stud solution, which is durable and as light as possible, has been under continuous development. Plastic and aluminium studs are known, but they are not as durable as studs with a steel body. Gravel and asphalt dust rapidly wear out the plastic or aluminium body surrounding the hard metal tip which easily leads to the hard metal tip coming off. Finnish patent applications 20080678 and 20080679 address studs and a winter tyre equipped with studs and include various solutions by which studs causing less wear to the road surface material can be created. The French patent FR 2131913 addresses winter tyres of the “trailer truck” type, in which 200-300 studs per tyre are used.

There is a common decree in the Scandinavian countries concerning vehicle tyre studs and the measurements and use of studs. The amendment to Decree 408/2003 dating 1 Jun. 2009 states the following: area of application, the number and installation of studs, type approval of studs, performer of measurements, the measurement of the piercing force of a passenger car tyre stud, the measurement of the piercing force of a light lorry tyre and a lorry tyre, and the studs intended for specified tyres. The new stud and its dimension according to the invention clearly fall within the permitted limits described in the Decree, although the number of studs is clearly greater than that stated in the Decree. The stud according to the invention has been thoroughly tested in various conditions by the VTT Technical Research Centre of Finland. The grip measurements were performed by Test World Oy, which is a measurement institute approved by the Finnish Transport Safety Agency (Trafi). Road wear was measured by Roadlux Ky using a method approved by Trafi (VTT method). The results achieved with the stud were compared to the limit values set in the Decree. A clear improvement in the wear of road surface material is achieved using the stud according to the invention, even when the number of studs in the tyre is doubled. The tests have indicated that only about 50% of the road surface material wears out with the lighter weight studs as compared to other studs. Practical tests on slippery ice have also indicated that winter tyres and studs according to the invention provide more than 40% better grip.

A winter tyre according to the invention is characterized in that the shape of the stud combined with the elasticity of the rubber composition of the winter tyre gives the stud a piercing force less than 120 N. All of the above-mentioned are achieved with a winter tyre and stud according to the invention.

As mentioned above, the tests carried out as such prove that a stud with these dimensions wears out only half of the road surface compared to studs now in use. The tests also prove that the grip is essentially better in both acceleration and braking than with known studs. It is also worth mentioning that the number of studs in the tyre does not have an effect on the wearing out of the road surface. This is due to the fact that the area of the bottom flange is that much smaller than in known studs, that the piercing force directed at the road surface presses the stud inside the tyre. However, the piercing force of the stud tip is sufficient enough for its purpose, i.e. it penetrates an icy surface at a sufficient enough force.

The object of the invention is also a stud for the tyre, which comprises a body part with a tip which resists wear, the cross-section of the tip being essentially round-shaped. The stud according to the invention is characterized by the cross-sectional area of the tip of the stud being 1.80-3.14 mm² Various embodiments of the invention have been presented in the dependent claims. The essential facts in these embodiments are the dimensions and shape of the bottom flange of the stud, the number of studs in the tyre, and the projection of the wear-resistant tip of the stud from the surface of the tyre, as well as the position of the studs on the tread of the tyre.

### DESCRIPTION OF THE INVENTION

The number of studs in the vehicle winter tyre is greater than that stated in the amendment to the Finnish Ministry of Transport and Communications Decree 408/2003 dating 1 Jun. 2009 concerning vehicle tyre studs. The winter tyre has more than 50 studs per one metre of the rolling circumference of the tyre. The number can also be more than 60, 70, 80, 90 or even more than 100 studs per one metre of the rolling circumference of the tyre. The size, weight and/or shape of the stud in the tyre is such that the wear of the road surface caused by such a studded tyre is not greater than that of a studded tyre equipped with studs which fulfil requirements. The shape and area of the bottom flange of the stud, together with the elasticity of the winter tyre rubber compound create a piercing force of less than 120 N for the stud. The measurement of the stud's piercing force and of the wear caused on the road surface by the studded tyre are performed using adequate measuring equipment, and the type approval of a stud measured in this way is valid only when used together with a compatible tyre. The projection of the tip of the stud from the surface of the tyre in a new tyre must be under 0.5 mm, and under 1.0 mm for a used tyre, advantageously ca. 0.5-0.8 mm. The studs can be placed onto the entire area of the tyre tread. It has been established that the studs at the edges of the tyre tread cause more wear on the road surface than studs at the centre of the tread.

A stud according to the invention comprises a body part with a tip which resists wear, the cross-section of the tip being essentially round-shaped and the area of the tip being 1.80-3.14 mm² Thus the diameter øa is 2.0 mm or less. The diameter of the bottom flange of the stud øb is 6.5-7.5 mm or less. The shape of the bottom flange can be round or a polygon. In principle, the shape of the bottom flange can be anything as long as it fulfils, together with the elasticity of the rubber compound, the requirement of a piercing force under 120 N.

The wear-resisting tip of the stud does not necessarily have to be a known hard metal tip; it can also be made of any other suitable material, such as a ceramic substance, an industrial diamond, or carbon nitride (CN₃). The elasticity of the winter tyre rubber compound is that of a normal rubber compound used in winter tyres. The rubber compound can be harder where the bottom flange is located, for instance 5-15 “Shores”, advantageously ca. 8 “Shores” harder than the surface rubber compound. The normal elasticity of a winter tyre rubber compound is 50-80 “Shores”.

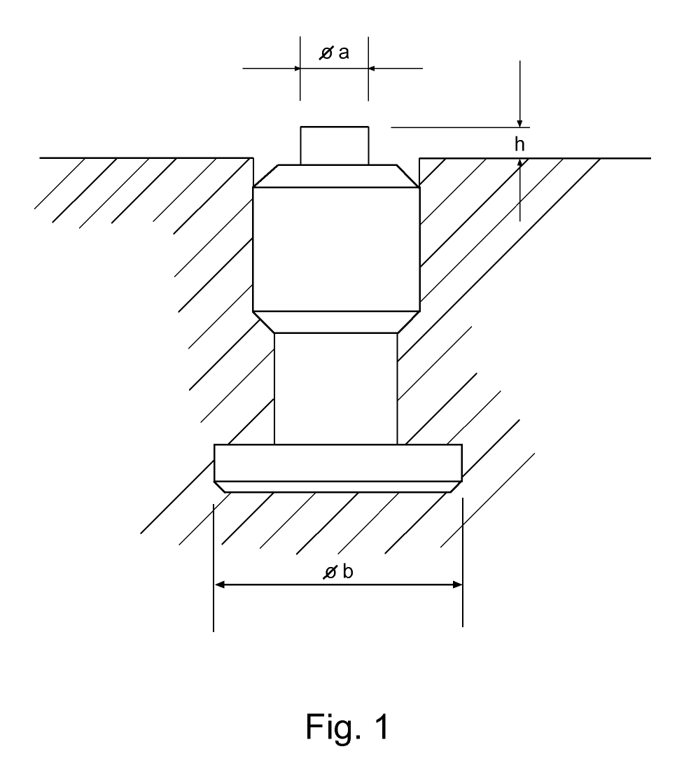

FIG. 1 shows a stud according to an embodiment of the invention fixed onto a tyre.

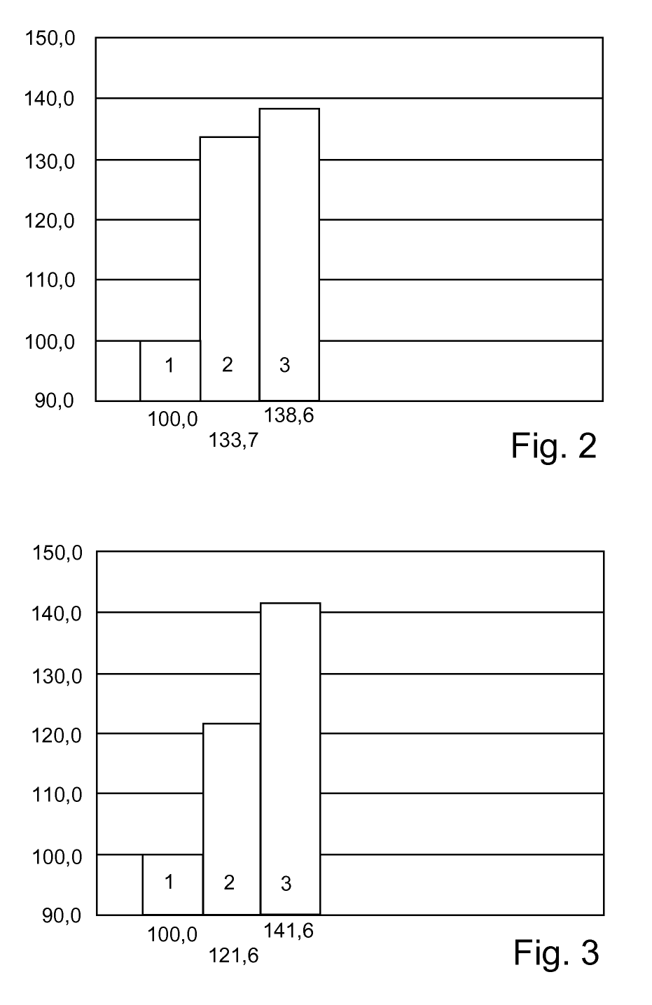

FIG. 2 shows an ABS braking test with three different studded tyres.

FIG. 3 shows an acceleration test with the same tyres.

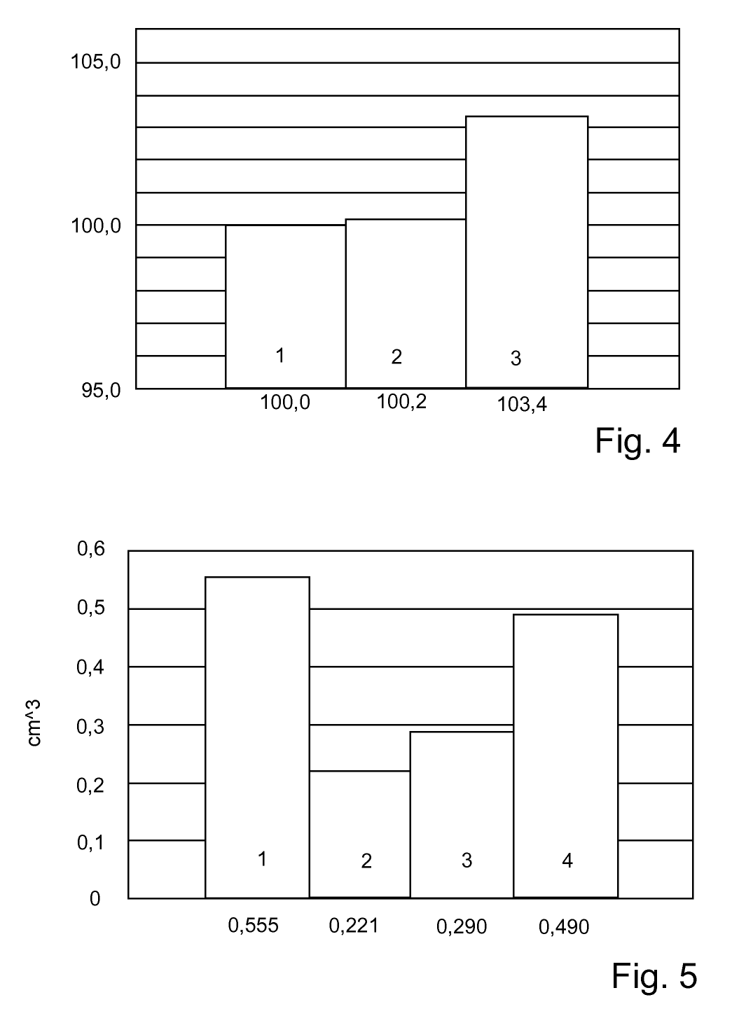

FIG. 4 shows lap times driven on an ice track, and

FIG. 5 shows road wear with four different tyres.

In FIGS. 2-5 reference tyre 1 is equipped with studs in compliance with the amendment to Decree 408/2003 dating 1 Jun. 2009. In FIGS. 2-4 the reference tyre has been directed at bar section 100 of the diagrams. In FIG. 2, bar 2 depicts the same tyre equipped with studs 2 according to the invention, and bar 3 equipped with other studs 3 according to the invention. The ABS braking test indicates that the results are 33.7 and 38.6 better than the result given by the reference tyre. FIG. 3 shows the average of the acceleration test TCS, in which bar 1 is the reference tyre, numbers 2 and 3 are tyres according to the invention, the same as in FIG. 2. The tests indicate that the results 21.6 and 41.6 are better than with reference tyres. FIG. 4 shows the averages of lap times driven on the ice track, which also show that the tyres and studs according to the invention yield better results than the reference tyres.

FIG. 5 indicates proof that the tyres and studs according to the invention are not just novelties; rather, the invention “also differs essentially from the prior art”, in other words its level of inventiveness is high.

Road wear with the reference tyre is 0.555 cm³,

with tyre 2 according to the invention; 0.221 cm³,
with tyre 3 according to the invention; 0.290 cm³, and
with the known Nokia Hakkapeliitta 5 tyre, purchased from a tyre shop, 0.490 cm³.

All of the above-mentioned tests driven on ice tracks not only yield fine theoretical numbers, but also show that the braking and acceleration tests done with the vehicle give a clear impression that vehicles clearly stop faster and accelerate better with the tyres and studs according to the invention are used as compared to known tyres and studs.

1. A vehicle winter tyre equipped with studs and which vehicle is intended for normal use and in which the number of studs in the tyre is greater than that stated in the amendment, dating 1 Jun. 2009, to the Finnish Ministry of Transport and Communications Decree 408/2003 concerning vehicle tyre studs, characterized in that the shape of the stud together with the elasticity of the rubber compound of the winter tyre create a piercing force of less than 120 N on the stud.

2. A tyre according to claim 1, characterized in that the size, weight and/or shape of the stud in the tyre is such that the projection (h) of the tip of the stud from the surface of a new tyre is less than 0.5 mm and remains less than 1.0 mm in a used tyre whereupon the wear caused to the road surface by this type of tyre is not greater than the wear caused by a studded tyre in compliance with regulations.

3. A tyre according to claim 1, characterized in that the elasticity of the rubber compound of the tyre is 50-80 “Shores”.

4. A tyre according to claim 1, characterized in that the elasticity of the rubber compound at the location of the bottom flange is ca. 5-15 “Shores” harder than the elasticity of the surface rubber compound.

5. A stud for a tyre according to claim 1, which is made up of a body part with a tip which resists wear, the cross-section of the tip being essentially round-shaped, characterized in that the cross-sectional area of the tip of the stud is less than 3.14 mm², advantageously 1.80-3.12 mm².

6. A stud according to claim 5, characterized in that the diameter of the bottom flange of the stud (øb) is for example 6.5-7.5 or less.

7. A tyre according to claim 2, characterized in that the elasticity of the rubber compound of the tyre is 50-80 “Shores”.

8. A tyre according to claim 2, characterized in that the elasticity of the rubber compound at the location of the bottom flange is ca. 5-15 “Shores” harder than the elasticity of the surface rubber compound.

9. A tyre according to claim 3, characterized in that the elasticity of the rubber compound at the location of the bottom flange is ca. 5-15 “Shores” harder than the elasticity of the surface rubber compound.

10. A stud for a tyre according to claim 2, which is made up of a body part with a tip which resists wear, the cross-section of the tip being essentially round-shaped, characterized in that the cross-sectional area of the tip of the stud is less than 3.14 mm², advantageously 1.80-3.12 mm².

11. A stud for a tyre according to claim 3, which is made up of a body part with a tip which resists wear, the cross-section of the tip being essentially round-shaped, characterized in that the cross-sectional area of the tip of the stud is less than 3.14 mm², advantageously 1.80-3.12 mm².

12. A stud for a tyre according to claim 4, which is made up of a body part with a tip which resists wear, the cross-section of the tip being essentially round-shaped, characterized in that the cross-sectional area of the tip of the stud is less than 3.14 mm², advantageously 1.80-3.12 mm².
